(19) United States
(12) Patent Application Publication
(10) Pub. No.: US 2006/0049303 A1
(43) Pub. Date: Mar. 9, 2006

(54) Mechanical density altitude compensation device for helicopter tail rotors

(76) Inventor: Darrell Wade Wilkerson, Irving, TX (US)

Correspondence Address: GARY C. COHN, PLLC, 1147 NORTH FOURTH STREET, UNIT 6E, PHILADELPHIA, PA, 19123, US

(21) Appl. No.: 11/209,540

(22) Filed: Aug. 23, 2005

Related U.S. Application Data
(60) Provisional application No. 60/603,692, filed on Aug. 23, 2004.

(51) Int. Cl. B64C 27/54

(52) U.S. Cl. 244/17.13

(57) ABSTRACT

A helicopter tail rotor pitch-range altering device is disclosed. The device is incorporated into the existing helicopter tail rotor pitch-change control system of a helicopter and automatically alters the amount of tail rotor pitch available from the helicopter's tail rotor pitch-change control system based on changes in density altitude. The device comprises an ambient air density sensing device and a movable member located within or located in proximity to the helicopter tail rotor pitch-change flight control system. In one embodiment, a sealed bellows is connected directly to a movable member within the helicopter tail rotor pitch-change control system. As density altitude changes, the length of the bellows changes accordingly and moves the movable member within the helicopter's tail rotor pitch-change control system providing a varying tail rotor pitch-range based on density altitude.

### CROSS-REFERENCE TO RELATED APPLICATIONS

This application claims benefit of U.S. Provisional Application No. 60/603,692, filed Aug. 23, 2004.

### BACKGROUND OF THE INVENTION

This invention relates to a device for altering the available pitch-range of a helicopter tail rotor based on changes in air density or changes in components of air density such as ambient air pressure, ambient air temperature or ambient air moisture content.

Most common rotor wing aircraft (helicopters) have a rotor system that consists of a main rotor and a tail rotor. The main rotor provides lift and translational force. The tail rotor provides sideward thrust that counteracts the torque affects induced on the helicopter by the driving of the main rotor. The sideward thrust not only counteracts the main rotor torque, it also provides yaw control or directional control for the helicopter. The pilot can vary the amount of sideward thrust put out by the tail rotor through controls, which are typically in the form of pedal inputs. The controls change the amount of pitch on the tail rotor. By actuating the controls, the pilot can adjust the amount of thrust that is produced by the tail rotor by varying the pitch of the tail rotor blades. More tail rotor pitch produces more tail rotor thrust.

Air density varies as a function of air pressure, air temperature, and the amount of moisture in the air. Air density decreases with decreasing air pressure, increasing air temperature and to a smaller extent increasing moisture content. Air density is sometimes expressed in terms of “density altitude”, which describes air density in terms of the equivalent altitude at which that same air density occurs in the Standard Atmosphere (a standardized mathematical model of the atmosphere). The higher the density altitude, the less dense the air is.

A helicopter tail rotor works less efficiently at higher density altitudes. The aircraft therefore has less tail rotor authority (i.e., maximum thrust that can be produced by the tail rotor) and less yaw control at higher density altitudes. If, however, one or more of the factors affecting tail rotor authority is properly changed, the tail rotor authority can be increased. The problem, however, with simply changing tail rotor operating parameters to provide the tail rotor authority needed at higher density altitudes is that these changes often cause too much thrust to be produced at lower density altitudes. Too much thrust can overload the helicopter airframe and drive train components as well as the tail rotor flight controls.

It is therefore desirable to vary the maximum level of thrust achievable by the tail rotor based on air density or density altitude. Numerous devices have been developed to accomplish this. U.S. Pat. No. 5,607,122 to Hicks et al. describes an apparatus including a microprocessor which calculates density altitude based on ambient air sensor inputs. The microprocessor produces an electronic control signal to an actuator that varies the geometry of a linkage member in the tail rotor control system, which in turn varies the pitch of the tail rotor blades. A similar system is described in a 1979 service manual for a Russian-manufactured helicopter.

U.S. Pat. No. 6,371,408 B1 to Halwes describes an apparatus that uses a sealed bellows that extends and retracts based on air temperature and air pressure changes. In this manner, the movement of the bellows closely reflects changes in air density. The bellows moves a target that is sensed by proximity sensors. The proximity sensors send signals to a logic circuit that activates a drive motor, varying the geometry of a linkage member while simultaneously moving the proximity sensor mount to bring the proximity sensors and mount into alignment with the target. This logic circuit also must detect whether proximity sensors are on or off and provide the appropriate signal to the drive motor for each condition. The Halwes apparatus, like the others, will cease operation if power to the unit is lost for any reason. Because of the operation of the proximity sensors, the Halwes apparatus is not as responsive and accurate as desired.

Accordingly, there is a need to provide a simple, dependable and accurate device for altering the available pitch-range of a helicopter tail rotor based on changes in air density or changes in components of air density such as ambient air pressure, ambient air temperature or ambient air moisture content.

### SUMMARY OF THE INVENTION

In one aspect, this invention is a helicopter tail rotor pitch-range control mechanism comprising:

a. a helicopter tail rotor pitch-change control system having at least one linkage;

b. a helicopter tail rotor having a tail rotor pitch that is variable in response to the helicopter tail rotor pitch-change control system; and

c. an air density compensation device that includes (1) a mechanical air sensing device having a moving member that moves in response to changes in ambient air pressure, ambient air temperature, ambient air moisture content or a combination of two or more of these and (2) a movable mechanism attached to the moving member of the air sensing device and movable in response to movement of the moving member of the air sensing device, said movable mechanism adapted to engage with at least one linkage member of the helicopter tail rotor pitch-change control system such that, in response to movement of the moving member of the air sensing device, the movable mechanism alters the range of pitch through which the helicopter tail rotor can be varied by the helicopter tail rotor pitch-change control system.

In a second aspect, this invention is an air density compensation device for a helicopter tail rotor pitch-change control system, the air density compensation device comprising (1) a mechanical air sensing device having a moving member that moves in response to changes in ambient air pressure, ambient air temperature, ambient air moisture content or a combination of two or more of these and (2) a movable mechanism attached to the moving member of the air sensing device and movable in response to movement of the moving member of the air sensing device, said movable mechanism adapted to engage with at least one linkage member of a helicopter tail rotor pitch-change control system such that the range of pitch through which the helicopter tail rotor can be varied by the helicopter tail rotor pitch-change control system is altered in response to movement of the moveable mechanism.

The invention provides a simple, mechanical apparatus for controlling the range of available tail rotor pitch in response to changes in ambient air conditions that affect air density. Those ambient air conditions may include ambient air pressure, ambient air temperature and, to a lesser extent, ambient air moisture content, all of which affect air density.

A “range” of tail rotor pitch is generally specified in terms of (1) the total included angle of tail rotor pitch through which the tail rotor can be adjusted (typically from a full left pedal to a full right pedal position) and (2) the location of that total included pitch-angle relative to zero tail rotor pitch. For example, for a helicopter where the tail rotor pitch can vary between minus five (−5) degrees (at full right pedal) and seventeen (17) degrees (at full left pedal) the tail rotor pitch range is defined by the total included pitch-angle of twenty-two (22) degrees with full right pedal at minus five (−5) degrees relative to zero tail rotor pitch. In this invention, a change or alteration in the range of tail rotor pitch may include a change in the total included pitch-angle, a change in the location of the included pitch-angle relative to zero tail rotor pitch, or changes to both the total included pitch-angle and its location. Thus, in the foregoing example, one way in which the pitch range can be altered is by increasing the included angle. For example, pitch range can be adjusted by changing the full left pedal setting to twenty (20) degrees, thereby increasing the included angle to twenty-five (25) degrees. Another way of changing the pitch range in the foregoing example is to move both full pedal positions by the same amount (and in same direction), to preserve the original included angle but change its location relative to zero tail rotor pitch. The full right pedal position may be changed to minus one (−1) degree and the full left pedal position to twenty-one (21) degrees, for example. This preserves the original twenty-two (22) degree included angle but changes its location relative to zero tail rotor pitch. It is often desirable to change both the included angle and location of the included angle relative to zero tail rotor pitch.

In its usual configuration, the mechanism of the invention permits the maximum pitch to which the tail rotor can be adjusted to increase with decreasing air density. This allows the tail rotor to assume a greater pitch under lower air density operating conditions, thereby increasing the thrust that can be generated by the tail rotor under the lower air density conditions. At higher air density conditions, the maximum available pitch that can be imparted to the tail rotor is more limited by the mechanism of the invention. This has the effect of limiting the maximum thrust that can be generated by the tail rotor at the higher air density conditions and helps to prevent over-thrust at higher air density conditions. The ability to vary the range of allowable tail rotor pitch with air density improves control over the vehicle under low air density conditions without over-thrusting during higher air density conditions.

As discussed in more detail below, the moveable mechanism may engage with a helicopter tail rotor pitch-change control system in various ways to control the range of available tail rotor pitch. One general type of design uses a moveable stop mechanism that engages with a linkage member of the helicopter tail rotor pitch-change control system and limits its range of movement. Movements of the stop mechanism alter the range of movement available to the helicopter tail rotor pitch-change control system, increasing or decreasing the available ranges of pitch. Another type of design includes a variable geometry link in the helicopter tail rotor pitch-change control system. Changes in the geometry of the variable geometry link (for example, a change in length of a member or a component thereof as described more below) increase or decrease the range of pitch through which the helicopter tail rotor pitch-change control system can move the tail rotor.

### BRIEF DESCRIPTION OF THE DRAWINGS

Having described the invention generally, specific embodiments are now described in more detail with respect to the Figures.

FIG. 1 is a perspective view of an embodiment of the tail rotor pitch-range control mechanism of the invention.

FIG. 2 is a side view, partially in section, of an air density compensation device of the invention.

FIG. 2A is a side view of an alternative embodiment of a moveable stop for use in the invention.

FIG. 3 is a side view of another embodiment of the air density compensation device of the invention.

FIG. 3A is a top view of an alternative embodiment of a moveable stop for use in the invention.

FIG. 4 is a side view of another embodiment of the air density compensation device of the invention.

FIG. 5 is an isometric view of an embodiment of an air sensing device for use in the invention.

FIG. 6 is a perspective view of a second embodiment of the tail rotor pitch-range control mechanism of the invention.

FIG. 7 is a side view of a variable geometry link for use in the invention.

FIG. 8 is a side view of another type of variable geometry link for use in the invention.

### DETAILED DESCRIPTION OF THE INVENTION

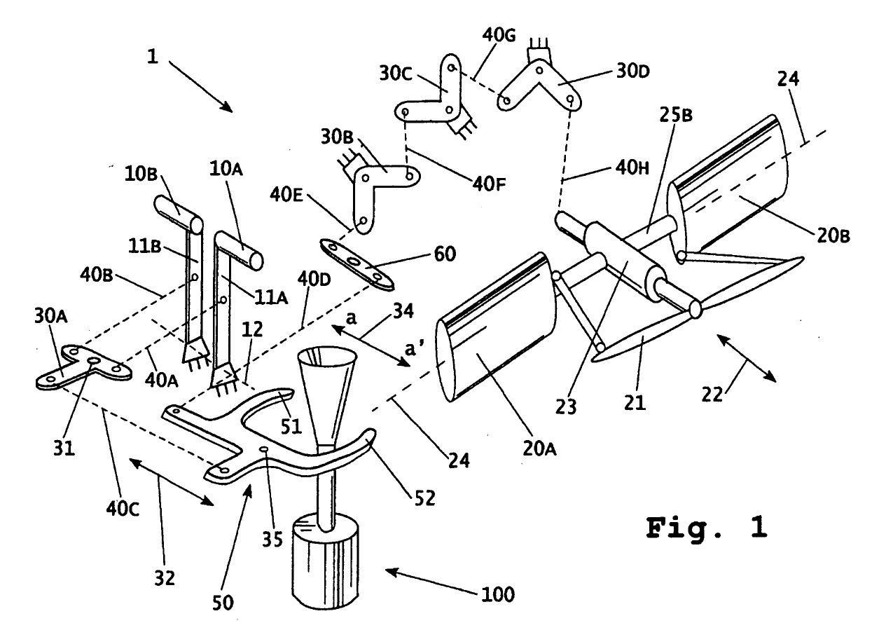

In FIG. 1, helicopter tail rotor pitch-range control mechanism 1 contains a helicopter tail rotor pitch-change control system that includes control pedals 10A and 10B and a series of linkage members that communicate with rotors 20A and 20B. Pedals 10A and 10B are mounted on cranks 11A and 11B, respectively. When pedals 10A and 10B are depressed, cranks 11A and 11B move about axis 12, actuating a series of linkage members that move lever 21 inwardly or outwardly in the direction shown by double-headed arrow 22. Lever 21 connects to rotor hubs 25A and 25B or directly to rotors 20A and 20B. The inward and outward movement of lever 21 causes rotor hubs 25A and 25B to rotate about axis 24, thereby changing the pitch of rotors 20A and 20B. As shown, the linkage members within the helicopter tail rotor pitch-change control system also include components such as linkage members 30A-D and 60, linkage member 50, and push/pull tubes 40A-H. However, the type and arrangement of the various components of the helicopter tail rotor pitch-change control system may vary significantly depending on the design of the particular aircraft. Linkage members and push/pull tubes may assume many alternative configurations in addition to the specific types shown in FIG. 1. In addition, cables, chains, and other mechanical devices and means (not shown) can be used as alternative or additional linkage members to create a suitable helicopter tail rotor pitch-change control system for a particular aircraft.

The embodiment shown in FIG. 1 includes an air density compensation device 100 with a moveable stop mechanism, which engages with linkage member 50. When either pedal 10A or 10B is actuated, linkage member 30A rotates about pivot point 31, moving push/pull tube 40C in the direction indicated by double-headed arrow 32. Push/pull tube 40C engages with linkage member 50, causing it to rotate about pivot point 35. The rotation of linkage member 50 causes arms 51 and 52 to rotate in the directions indicated by double-headed arrow 34. Thus, for example, when pedal 10A is depressed, arms 51 and 52 rotate to the right (i.e., toward arrowhead a′), until arm 51 contacts the moveable-stop mechanism of air density compensation device 100 and further movement of linkage member 50 is prevented. Conversely, when pedal 10B is depressed, arms 51 and 52 rotate to the left (i.e., toward arrowhead a) until arm 52 contacts the moveable stop mechanism of air density compensation device 100 and further movement of linkage member 50 is prevented. Thus, the pitch of tail rotors 20A and 20B can be increased or decreased by actuating pedals 10A and/or 10B, with the movement of the helicopter tail rotor pitch-change control system and the range of allowable pitch being limited by the engagement of either of arms 51 or 52 with the moveable stop mechanism of air density compensation device 100.

In the embodiment shown in FIG. 1, a common arrangement of pedals is shown, in which operation of the left pedal 10A increases tail rotor pitch (and correspondingly, thrust), and right pedal 10B decreases tail rotor pitch (correspondingly reducing thrust).

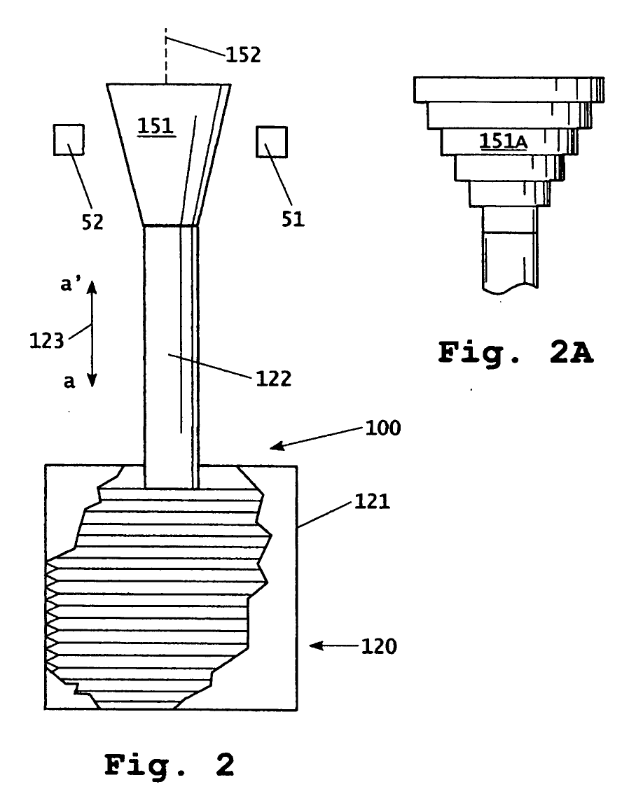

The moveable stop mechanism and air density compensation device 100 shown in FIG. 1 are shown in greater detail in FIG. 2. In FIG. 2, air density compensation device 100 includes sealed bellows 120, which is a preferred type of mechanical air sensing device. Moving member 122 is attached to bellows 120 and moves in response to changes in ambient air pressure, ambient air temperature, ambient air moisture content, or two or more of these. Bellows 120 is charged with a gas and sealed from the ambient atmosphere. Changes in ambient air pressure, ambient air temperature and/or ambient air moisture content cause the gas sealed within bellows 120 to expand or contract, causing bellows 120 to correspondingly change in volume. Those volume changes cause moving member 122 to extend and retract relative to bellows frame 121 (and relative to a fixed position on the aircraft), in the direction indicated by double-headed arrow 123 in FIG. 2. Frame 121 is generally a rigid member having openings allowing bellows 120 to be open to the atmosphere.

Stop member 151 is affixed to moving member 122 and moves with it. In the embodiment shown in FIG. 2, stop member 151 has a varying geometry along its length, decreasing in width from top to bottom (in the orientation shown). Stop member 151 is positioned between arms 51 and 52 of linkage member 50. Upward or downward movements of moving member 122 change the position of stop member 151 relative to arms 51 and 52, so that the width of stop member 151 at the level of arms 51 and 52 in turn changes. When moving member 122 moves downwardly (in the orientation shown), a wider width portion of stop member 151 is positioned between arms 51 and 52. Conversely, when moving member 122 moves upwardly (in the orientation shown), a narrower portion of stop member 151 becomes positioned between arms 51 and 52.

Higher air density conditions cause the ambient atmospheric conditions to compress bellows 120. This causes moving member 122 to retract and, in the orientation shown, move downward. The downward movement of moving member 122 presents a wider width portion of stop member 151 to arms 51 and 52 of linkage member 50. This wider width reduces the range of movement that is available to linkage member 50 before one of arms 51 and 52 contacts stop member 151. This in turn reduces the range of pitches to which rotors 20A and 20B can be adjusted. As illustrated in FIG. 2, the change in width of stop member 151 affects the stop position of both of arms 51 and 52. However, the geometry of stop member 151 may be designed such that changes in the position of stop member 151 alter the allowable range of movement of only one of arms 51 and 52. It is particularly desirable that the movement of arm 51 before it contacts stop member 151 becomes more limited with increasing air density conditions as this reduces the maximum pitch angle that can be imparted to rotors 20A and 20B at higher air density conditions, and thus helps to avoid over-thrust conditions. It may or may not be necessary or desirable to change the movement of arm 52 before it contacts stop member 151.

In lower air density conditions, the ambient atmospheric conditions allow the bellows 120 to expand, causing moving member 122 to extend and (in the orientation shown) move upwardly. This presents a narrower portion of stop member 151 to linkage member 50, allowing it a greater range of motion before arms 51 or 52 contact stop member 151. This in turn allows rotors 20A and 20B to be moved through a greater range of pitch. In the lower air density conditions, it is generally desired to increase the permitted movement of arm 51 before it contacts stop member 151, as this allows the maximum pitch angle that can be imparted to rotors 20A and 20B to be increased under those conditions, increasing the amount of thrust that is available. As before, it may or may not be necessary or desirable to change the movement of arm 52 before it contacts stop member 151.

In FIG. 2, stop member 151 has a width that decreases continuously along its length. The continuous variation in width allows for a potentially infinite number of potential stop positions. In an alternative embodiment, as shown in FIG. 2A, the width of stop member 151A changes in a step-wise manner along its length. This design allows stop member 151A to make a series of discrete changes in the stop position of the helicopter tail rotor pitch-change control system as stop member 151A moves in response to changes in ambient air conditions. Each discrete width is designed to allow an appropriate range of tail rotor pitch positions for a discrete range of ambient air conditions. Depending on the design of the aircraft and the anticipated usage conditions (typically, altitude ranges for which the aircraft is designed), as few as two or as many as 20 or more (such as from 3-15 or from 3-10) discrete stop positions can be provided by the variable width stop member. Typically, each discrete stop position on the variable width stop member would correspond to a specific range of density altitude conditions under which that particular stop position would be engaged. For example, a first (widest) stop position may correspond to a density altitude of sea level to 500-2000 feet. The next widest stop position might then correspond to a density altitude of, for example, from 2000 to 3000 feet. Thus, each succeeding smaller width portion of stop member 151A would represent a setting that is implemented at a correspondingly higher density altitude range. The particular minimum and maximum density altitudes that correspond to each stop position are a matter of design choice. The range of density altitudes for each stop position (i.e., the difference between the maximum and minimum density altitudes for each particular stop position) is also a matter of design choice. It is contemplated that each stop position will correspond to a density altitude range of from 500 to 3000 feet, especially about 500 to 2000 feet or about 500-1200 feet, from the minimum to maximum density altitude at which it will be engaged.

Air density is related to air pressure, air temperature, and air moisture content according to the relationship
D=Pₐ/RₐT+P_{w}/R_{w}T
where D represents air density, Pₐ is the dry air pressure, Rₐ is the gas constant for dry air, P_{w} is the water vapor pressure, R_{w} is the gas constant for water vapor, and T is the absolute temperature. Thus, at constant temperature, decreases in air pressure reduce air density, whereas at constant air pressure, temperature increases cause air density to decrease. The gas sealed in bellows 120 expands and contracts in response to changes in ambient air pressure and in response to changes in ambient air temperature, and therefore can react to air density increases or decreases that arise due to a change in either air pressure or air temperature. The bellows typically cannot respond to changes in air moisture content. However, as changes in air moisture content tend to have lesser affects on air density than do changes in pressure and temperature, the bellows nonetheless will provide responses that closely approximate changes in air density.

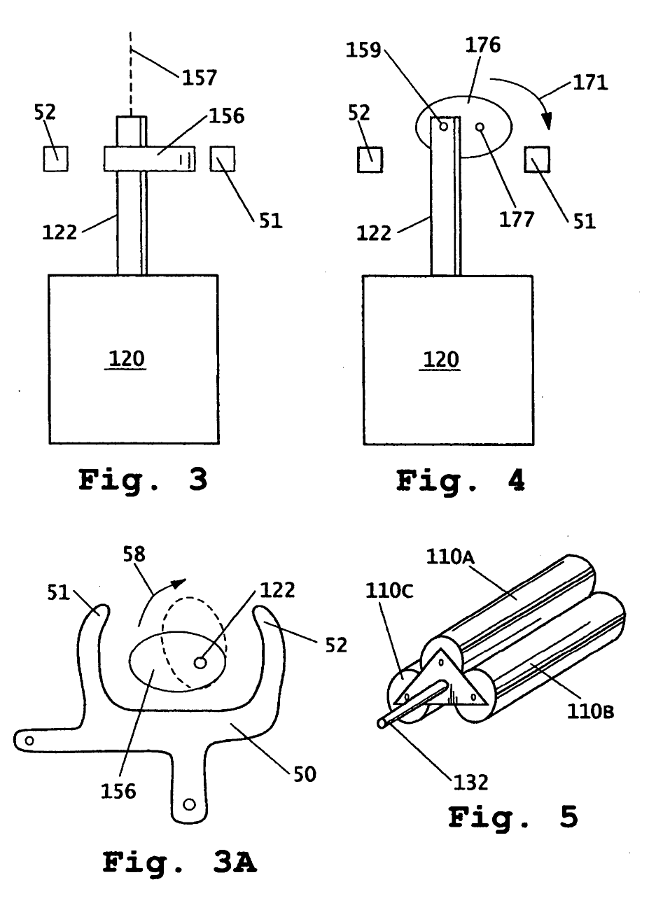

Various alternative stop member designs can be substituted for those shown in FIGS. 1, 2 and 2A. In FIGS. 3 and 3A, stop member 156 is a cam mounted asymmetrically about moving member 122. Cam 156 is mounted on moving member 122 such that as moving member 122 extends and retracts with changes in volume in bellows 120, cam 156 is rotated about axis 157. This can be accomplished using a moving member 122 with a helical exterior, and a cam having a correspondingly threaded bore. Up and down movement of moving member 122 will result in a rotation of cam 156 if the vertical (as shown) position of cam 156 is held constant. The rotation of cam 156 about axis 157 changes the effective cross-section (or width) of cam 156 that is presented to arms 51 and 52 of linkage member 50 as air density changes. An example of the type of rotation that can be produced is illustrated in FIG. 3A, in which a low air density position of cam 156 is shown in phantom, and the direction of movement from high air density to low air density is indicated by arrow 158. This in turn alters stop positions with changes in air density (or component thereof), affecting the available rotor pitch range of motion as before. Note that in this embodiment, the allowable movement of arm 51 increases with decreasing air density, whereas the allowable movement of arm 52 in the opposite direction may be increased, unchanged or also decreased, depending on the particular geometry of stop member 156. In the embodiment shown in FIG. 3A, rotation of cam 156 changes the stop position of arm 51 of linkage member 150, but affects little change in the stop position of arm 52.

Another alternative stop member design is shown in FIG. 4. In FIG. 4, cam 176 is pivotably and asymmetrically mounted about pivot point 177. Cam 176 is pivotably mounted to moving member 122 at pivot point 159. In this embodiment, decreasing air density causes moving member 122 to move upwardly (in the orientation shown) as before, causing cam 176 to rotate in the direction indicated by arrow 171. This reduces the effective cross-section (or width) of cam 176 that is presented to arm 51, increasing the allowable range of motion of arm 51 before it contacts cam 176, and increasing the range of allowable pitch motion as before. Note that in this embodiment as well, the allowable movement of arm 51 increases with decreasing air density, whereas the allowable movement of arm 52 in the opposite direction may be increased, unchanged or also decreased, depending on the particular geometry of stop member 176. In the embodiment shown in FIG. 4, rotation of cam 176 results in a significant change in the stop position of arm 51 but little or no change in the stop position of arm 52.

Other moveable stop designs can of course be substituted for the particular types described above. For example, the cam designs shown in FIGS. 3 and/or 4 may be replaced with a cam having a serrated outer surface. This allows for step-wise changes in the allowable position of arms 51 and/or 52, as described with respect to the moveable stop design illustrated in FIG. 2A. In addition, any design that changes the available pitch range in the desired manner can be used. As before, preferred designs will permit the maximum allowable tail rotor pitch to decrease with increasing air density (or component thereof) and permit it to increase with decreasing air density (or component thereof).

Design modifications can be made to the bellows and to the linkage system that connects the moving member of the air sensing device with the moveable stop. In general, the air sensing device can be of any mechanical design, provided that it includes a movable member that moves in a predictable way in response to changes in ambient air pressure, ambient air temperature and/or ambient air moisture content.

For example, an alternative mechanical air sensing device design includes a housing member and a piston. The housing and piston together define a gas-filled chamber which is sealed from the atmosphere, such as through O-rings or similar seals. The piston is slidably mounted within the housing. The piston extends and contracts with changes in ambient air density (or component thereof such as air pressure and/or temperature) in much the same manner as moveable member 122 of FIG. 2, moving a moveable stop member as before. Another alternative air sensing device replaces bellows 120 of FIG. 2 with a flexible, gas-filled bladder. Like the bellows described above, the gas-filled bladder will respond to changes in ambient air pressure and ambient air temperature, but not changes in ambient air moisture content. As before, this provides a good approximation of air density changes.

A bellows containing a vacuum can be substituted for the bellows, housing-and-piston or gas-filled bladder described above. The vacuum-filled bellows is made of a flexible material or otherwise constructed such that the volume enclosed by the bellows changes with air pressure only. A moving member is affixed to the bellows as before, with the moving member extending with reduced ambient air pressure and retracting with increasing ambient air pressure. This type of bellows does not react to variations in ambient air temperature, and thus its movement is sometimes a poorer approximation of air density than the bellows designs described before. However, a vacuum-filled bellows can if desired be used in conjunction with another device that produces a mechanical motion in response to changes in ambient air temperature, so that the devices together produce a movement that more closely correlates with changes in air density.

The linkage system connecting the air sensing device to the moveable stop that is illustrated in FIG. 2 is a particularly simple design, in which the moveable stop is connected directly to the moving member and moves with it. However, the particular design of the linkage system is not considered to be critical. Various kinds of linkage systems can be used for this purpose, including for example, various levers, bell cranks, push-pull rods or tubes, cables, sleeve-and-cable systems, hydraulic systems, and the like. All that is required is that the moveable stop be mechanically connected to the moving member so the moveable stop moves in a known way in response to movements of the moving member.

As shown in FIG. 5, multiple air sensing devices can be used together. In FIG. 5, air sensing devices 110A, 110B and 110C have moving members that are joined together such that they produce a common moving end 132. The moveable stop (not shown) is connected to common moving end 132 in a manner as described before. The movement of moving end 132 is a summation of the output forces of the individual air sensing devices 110A, 110B and 110C. Multiple air sensing devices may be used for purposes of providing redundancy, thus providing an additional margin of safety. Air sensing devices of different types may be used together. For example, an air sensing device that responds only to ambient air pressure changes may be coupled to another air sensing device that responds to ambient air temperature changes and/or ambient air moisture content changes. Another reason to use multiple air sensing devices is simply to multiply the force that is available to move the moveable stop or to resist loads that may be applied by the tail rotor pitch-control system.

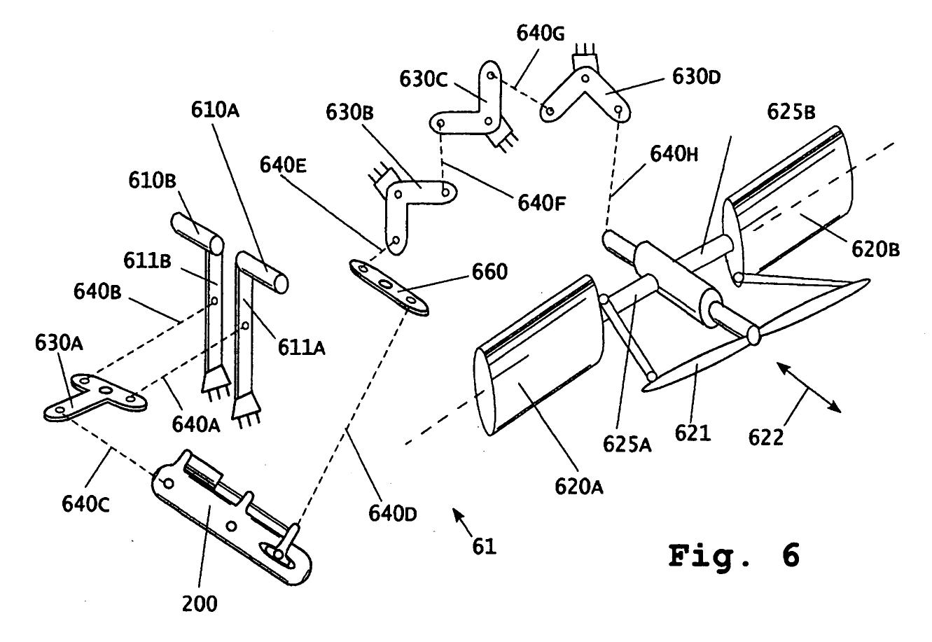

FIG. 6 illustrates an alternative embodiment of the invention, in which a variable geometry linkage is used to affect the range of available rotor pitches.

In FIG. 6, helicopter tail rotor pitch-range control mechanism 61 contains a helicopter tail rotor pitch-change control system that includes control pedals 610A and 610B and a series of linkage members 630A-D and 660 and push/pull tubes 640A-H that communicate with rotors 620A and 620B. Pedals 610A and 610B are mounted on cranks 611A and 611B, respectively, as before, actuating a series of linkage members that move lever 621 inwardly or outwardly in the direction shown by double-headed arrow 622 to effect changes in the pitch of rotors 620A and 620B. In this embodiment, linkage members 630A-D and push/pull tubes 640A-H perform the same functions as described with respect to analogous features shown in FIG. 1. However, the embodiment shown in FIG. 6 does not include an air density compensation device with a moveable stop as shown in FIG. 1.

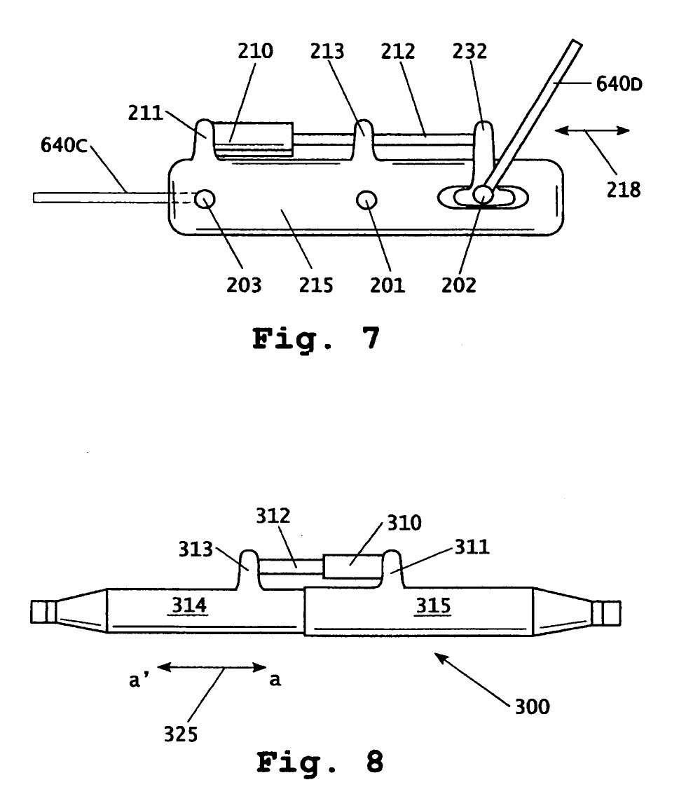

Instead, the helicopter tail rotor pitch-change control system shown in FIG. 6 includes an air density compensation device with a variable geometry link 200. A specific embodiment of variable geometry link 200 is illustrated in FIG. 7. In the embodiment shown in FIG. 7, the variable geometry link 200 includes lever 215 having a pivot point 201 through which link 200 is pivotably affixed to a fixed point. Near one end of lever 215 is attachment point 203 for receiving input from the pedal side of the helicopter tail rotor pitch-change control system. Near the opposite end of lever 215 is a second, moveable attachment point 202 for providing output to the tail rotor side of the helicopter tail rotor pitch-change control system. In the embodiment shown, the position of attachment point 202 relative to pivot point 201 is variable in response to movements of mechanical air sensing device 210. Mechanical air sensing device 210 is as described before, and includes moving member 212 that extends and retracts in the direction indicated by double-headed arrow 218 with changes in ambient air density (or a component thereof such as air pressure, air temperature or air moisture content). In the embodiment shown in FIG. 7, air sensing device 210 is mounted onto variable geometry link 200, being held in a fixed position against support 211. Moving member 212 passes through optional guide 213 and connects to moveable attachment point 202 through tab 232.

As air sensing device 210 and moving member 212 extend due to a decrease in ambient air density (or component thereof), tab 232 and moveable attachment point 202 are pushed outwardly, away from pivot point 201. The distance from pivot point 201 to attachment point 202 is thereby increased in response to reduced ambient air density. When the helicopter tail rotor pitch-change control system is actuated, push/pull tube 640C moves attachment point 203 of lever 215. The farther that attachment point 202 is pushed away from pivot point 201, the greater the movement of attachment point 202 will become in response to a given movement of attachment point 203. The greater range of movement of attachment point 202 creates a correspondingly greater range of movement of push/pull tube 640D and increases the range of pitch (in particular, the included angle) that is imparted to tail rotors 620A and 620B. Similarly, increases in air density cause air sensing device 210 and moving member 212 to retract, reducing the distance from pivot point 201 to attachment point 202, thereby reducing the amount of pitch change (i.e. reduces the included angle) that is translated to tail rotors 620A and 620B by a given movement of attachment point 203.

Equivalent results can be obtained by modifying variable geometry link 200 so that the position of pivot point 201 and/or attachment point 203 is changed in response to changes in air density. Note that the effect of changing the position of attachment point 203 is opposite that of moving attachment point 202. Outward movement of attachment point 203 (i.e. to increase its distance from pivot point 201) will reduce the amount of pitch change that results from a given lateral movement of attachment point 203. For that reason, the air sensing device in that case must be configured so that attachment point 203 is moved closer to pivot point 201 in response to decreasing air density. The effect of moving pivot point 201 in response to air density changes will vary according to the particular design of the variable geometry linkage member.

In the embodiment shown in FIG. 7, air sensing device 210 is mounted directly onto variable geometry link 200. This is not required. Air sensing device 210 may be mounted separately from variable geometry link 200 and operatively attached to it using a variety of types of linkages. As before, various types of linkage members may be inserted between the moveable member of the air sensing device and the variable geometry link. Suitable such linkage members include those described above. The linkage design should be such that the linkage does not impede movement of lever 215 about pivot point 201.

Although the variable geometry link is illustrated in FIG. 7 with a linear geometry, equivalently functioning variable geometry linkage members can be made having various non-linear geometries. For example, angled linkage members 630 may be adapted in analogous fashion to function as the variable geometry link.

Another type of variable geometry link is illustrated in FIG. 8. In FIG. 8, a variable length push/pull tube mechanism 300 is positioned as a linkage replacing a conventional push/pull tube in the helicopter tail rotor pitch-change control system, such as any of tubes 40 or 640 in FIGS. 1 and 6. Thus, in FIG. 8, variable length push/pull tube 300 includes sections 314 and 315 that are slidably mounted together so that section 314 can move with respect to section 315 in the direction indicated by double-headed arrow 325. Air sensing device 310, which may be of any of the types described previously, is mounted onto section 315 of variable length push/pull tube 300 via support 311. Moveable member 312 connects to tab 313 on moving section 314. As moveable member 312 extends and retracts as a function of changes in air density (or component thereof) as before, section 314 moves correspondingly outwardly and inwardly, and the length of the variable length push/pull tube mechanism 300 is correspondingly altered. This change in the length of variable length push/pull tube mechanism 300 alters the range of available helicopter tail rotor pitch. This approach tends to bias the tail rotor pitch range towards one full pedal position or the other, i.e., tends to preserve the included angle of the pitch range while changing its location relative to zero tail rotor pitch. For example, if this approach were used to give a seven degree increase in tail rotor pitch at full left pedal, the tail rotor blade pitch angle will be increased by seven degrees at full left pedal and at full right pedal the tail rotor blade pitch will be biased towards the full left pedal position by about seven degrees as well. Therefore, in this example, if the full right pedal position were originally minus eight degrees, the new full right pedal position will be about minus one degree.

It is also noted that in this embodiment, the push/pull tube is subjected to compressive and/or tensile forces when the pitch change control system is actuated. These forces can in some cases diminish, exaggerate or overcome the motion of moving member 312 in response to air density changes. For this reason, it is preferred that the moveable mechanism of the air density compensation device be designed and used in a manner such that compressive or tensile forces that are applied to it during operation of the helicopter tail rotor pitch-change control system are minimized or eliminated.

Also as before, air sensor 310 can be separated from push/pull tube mechanism 300 and be operatively joined to it via a variety of types of linkages.

The various types of moveable mechanisms as described above can be used in combination if desired or necessary to obtain the desired effect on tail rotor pitch range.

In addition, the air density compensation device may be used in conjunction with or in addition to conventional types of air compensation devices, to provide, for example, redundant or back-up systems. The mechanical air sensing device may be supplemented with other types of air sensing devices, such as air temperature, air pressure or air moisture content sensors or detectors, to supplement the mechanical air sensing device. The air density compensation device may further include one or more display means for reporting one or more operating parameters or other information, such as the position of the moving member, the pitch range (or component thereof), the maximum allowable tail rotor pitch, the air density (or component thereof) represented by the position of the moving member of the air sensing device, and the like.

Although several preferred embodiments of the present invention have been described in detail herein, the invention is not limited hereto. It will be appreciated by those having ordinary skill in the art that various modifications can be made without materially departing from the novel and advantageous teachings of the present invention. Accordingly, the embodiments disclosed herein are provided by way of example only. It is to be understood that the scope of the present invention is not to be limited thereby, but is to be determined by the claims which follow.

What is claimed is:

1. An air density compensation device for a helicopter tail rotor pitch-change control system, the air density compensation device comprising (1) a mechanical air sensing device having a moving member that moves in response to changes in ambient air pressure, ambient air temperature, ambient air moisture content or a combination of two or more thereof and (2) a movable mechanism attached to the moving member of the mechanical air sensing device and movable in response to movement of the moving member of the mechanical air sensing device, said movable mechanism adapted to engage with at least one linkage member of a helicopter tail rotor pitch-change control system such that the range of pitch through which the helicopter tail rotor can be varied by the helicopter tail rotor pitch-change control system is altered in response to movement of the moveable mechanism.

2. The air density compensation device of claim 1, wherein the mechanical air sensing device includes a bellows defining an enclosed cavity containing a gas.

3. The air density compensation device of claim 1, wherein the mechanical air sensing device includes a housing member and a piston that together define a gas-filled chamber which is sealed from the atmosphere, and the piston is moveable in response to changes in air density.

4. The air density compensation device of claim 1, wherein the mechanical air sensing device includes a gas-filled flexible bladder.

5. The air density compensation device of claim 1, wherein the air density compensation device includes multiple air sensing devices that are connected to a common moving member.

6. The air density compensation device of claim 1, wherein the moveable mechanism is a moveable stop.

7. The air density compensation device of claim 6, wherein the moveable stop has a varying cross-sectional shape.

8. The air density compensation device of claim 6, wherein the moveable stop is a pivoting cam.

9. The air density compensation device of claim 6, wherein the moveable stop is a cam adapted to rotate upon movement of the moving member.

10. The air density compensation device of claim 1, wherein the moveable mechanism is a variable geometry linkage member.

11. The air density compensation device of claim 1, wherein the moveable mechanism is a variable length push/pull tube.

12. A helicopter tail rotor pitch-range control mechanism comprising:
a. a helicopter tail rotor pitch-change control system having at least one linkage;
b. a helicopter tail rotor having a tail rotor pitch that is variable in response to the helicopter tail rotor pitch-change control system; and
c. an air density compensation device that includes (1) a mechanical air sensing device having a moving member that moves in response to changes in ambient air pressure, ambient air temperature, ambient air moisture content or a combination of two or more thereof and (2) a movable mechanism attached to the moving member of the air sensing device and movable in response to movement of the moving member of the air sensing device, said movable mechanism adapted to engage with at least one linkage member of a helicopter tail rotor pitch-change control system such that, in response to movement of the moving member of the air sensing device, the movable mechanism alters the range of pitch through which the helicopter tail rotor can be varied by the helicopter tail rotor pitch-change control system.

13. The control mechanism of claim 12, wherein the mechanical air sensing device includes a bellows defining an enclosed cavity containing a gas.

14. The control mechanism of claim 12, wherein the mechanical air sensing device includes a housing member and a piston that together define a gas-filled chamber which is sealed from the atmosphere, and the piston is moveable in response to changes in air density.

15. The control mechanism of claim 12, wherein the mechanical air sensing device includes a gas-filled flexible bladder.

16. The control mechanism of claim 12 wherein the air density compensation device includes multiple air sensing devices that are connected to a common moving member.

17. The control mechanism of claim 12, wherein the moveable mechanism is a moveable stop.

18. The control mechanism of claim 17, wherein the moveable stop has a varying cross-sectional shape.

19. The control mechanism of claim 17, wherein the moveable stop is a pivoting cam.

20. The control mechanism of claim 17, wherein the moveable stop is a cam adapted to rotate upon movement of the moving member.

21. The control mechanism of claim 12, wherein the moveable mechanism is a variable geometry linkage member.

22. The control mechanism of claim 12, wherein the moveable mechanism is a variable length push/pull tube.
